(19) United States
(12) Patent Application Publication
(10) Pub. No.: US 2021/0046806 A1
(43) Pub. Date: Feb. 18, 2021

(54) BLOWING DEVICE

(71) Applicant: DENSO CORPORATION, Kariya-city (JP)

(72) Inventors: Yusuke KOMATSUBARA, Kariya-city (JP); Hitoshi NINOMIYA, Kariya-city (JP); Kazushi SHIKATA, Kariya-city (JP); Takahito NAKAMURA, Kariya-city (JP)

(73) Assignee: DENSO CORPORATION, Kariya-city (JP)

(21) Appl. No.: 17/087,876

(22) Filed: Nov. 3, 2020

Related U.S. Application Data
(63) Continuation of application No. PCT/JP2019/014980, filed on Apr. 4, 2019.

(30) Foreign Application Priority Data
May 7, 2018 (JP) 2018-089233

(51) Int. Cl. B60H 3/02; B60H 1/34

(52) U.S. Cl. CPC B60H 3/022; B60H 2001/3471; B60H 1/345; B60H 1/3407

(57) ABSTRACT

A blowing device includes a passage member and a passage switching device. The passage member is inserted into an air passage configured to blow a main air into the vehicle cabin. The passage member is configured to blow an added-value air. The passage member includes, in the air passage, a passage opening portion through which the added-value air is blown toward a passenger separately from the main air. The passage member defines a hole portion and the passage switching device is a damper or a rotary door. The damper or the rotary door closes the hole portion to allow the added-value air to flow out through the passage opening portion and fluidly connects the hole portion to the air passage to allow the main air to flow out through both the passage opening portion and a region of the air passage other than the passage opening portion.

### CROSS REFERENCE TO RELATED APPLICATIONS

The present application is a continuation application of International Patent Application No. PCT/JP2019/014980 filed on Apr. 4, 2019, which designated the U.S. and claims the benefit of priority from Japanese Patent Application No. 2018-089233 filed on May 7, 2018. The entire disclosures of all of the above applications are incorporated herein by reference.

### TECHNICAL FIELD

The present disclosure relates to a blowing device configured to blow an air into a vehicle cabin.

### BACKGROUND ART

A device that supplies an added-value air, which is an air to which a predetermined value is added, with the vehicle cabin has been known. The added-value air may be a humidified air, an aroma air with scent, or a cool air for awakening a passenger.

### SUMMARY

A blowing device is configured to blow an air into a vehicle cabin. The blowing device includes a passage member inserted into an air passage from an outside of a wall of the air passage and a passage switching device. The air passage is configured to blow a main air into the vehicle cabin. The passage member is configured to blow an added-value air having an added value that is different from that of the main air. The passage member includes, in the air passage, a passage opening portion through which the added-value air is blown toward a passenger separately from the main air. The passage member defines a hole portion in a portion of the passage member that is located in the air passage. The passage switching device is a damper or a rotary door, each of which is configured to selectively open and close the hole portion of the passage member. The damper or the rotary door is configured to close the hole portion of the passage member in a first state to allow the added-value air to flow out through the passage opening portion via the passage member. The damper or the rotary door is also configured to fluidly connect the hole portion of the passage member to the air passage in a second state to allow the main air to flow out through both the passage opening portion and a region of the air passage other than the passage opening portion.

### BRIEF DESCRIPTION OF THE DRAWINGS

FIG. 1 is a schematic view of a vehicle cabin of a vehicle in which a blowing device in a first embodiment is mounted.

FIG. 2 is a cross-sectional view of the blowing device in the first embodiment.

FIG. 3 is a front view of the blowing device viewed in a direction of an arrow III in

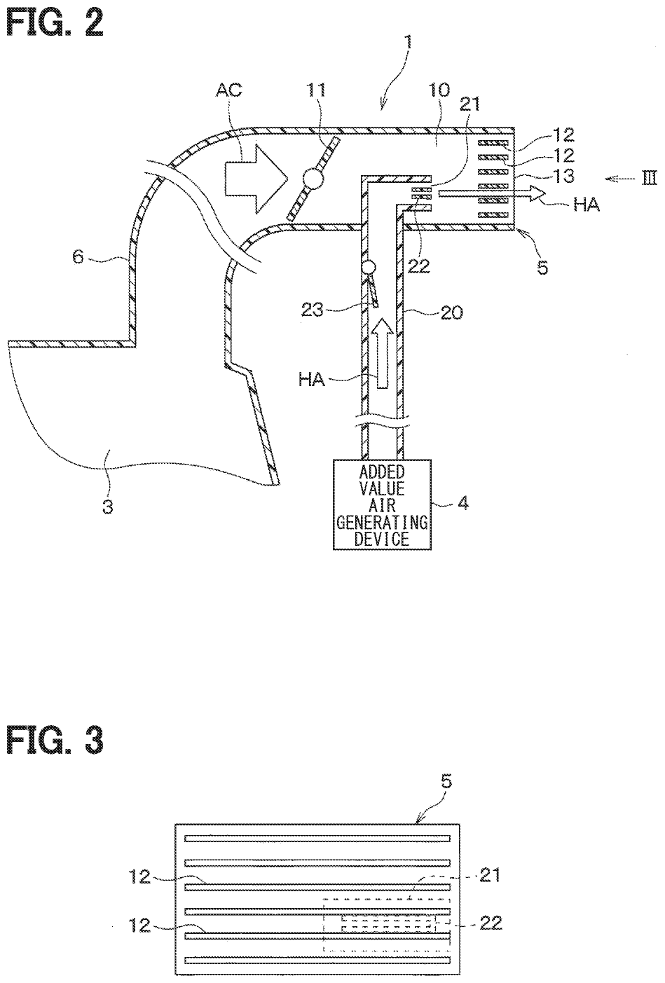

FIG. 2.

FIG. 4 is a cross-sectional view of a blowing device in a second embodiment.

FIG. 5 is a front view of the blowing device viewed in a direction of an arrow V in

FIG. 4.

FIG. 6 is a cross-sectional view of a blowing device in a third embodiment.

FIG. 7 is a cross-sectional view taken along a line VII-VII in FIG. 6.

FIG. 8 is a cross-sectional view of the blowing device in the third embodiment.

FIG. 9 is a cross-sectional view taken along a line IX-IX in FIG. 8.

FIG. 10 is a cross-sectional view of a blowing device in a third embodiment.

FIG. 11 is a cross-sectional view taken along a line XI-XI in FIG. 10.

FIG. 12 is a cross-sectional view of a blowing device in a fourth embodiment.

FIG. 13 is a cross-sectional view of the blowing device in the fourth embodiment.

FIG. 14 is a cross-sectional view of a blowing device in a fifth embodiment.

FIG. 15 is a cross-sectional view of the blowing device in the fifth embodiment.

FIG. 16 is a cross-sectional view of a blowing device in a sixth embodiment.

FIG. 17 is a cross-sectional view of the blowing device in the sixth embodiment.

FIG. 18 is a cross-sectional view of a blowing device in a seventh embodiment.

FIG. 19 is a cross-sectional view of the blowing device in the seventh embodiment.

FIG. 20 is a cross-sectional view of a blowing device in an eighth embodiment.

FIG. 21 is a cross-sectional view of the blowing device in the eighth embodiment.

FIG. 22 is a front view of a blowing device in a ninth embodiment.

FIG. 23 is a front view of a blowing device in a tenth embodiment.

FIG. 24 is a front view of a blowing device in an eleventh embodiment.

FIG. 25 is a front view of a blowing device in a twelfth embodiment.

FIG. 26 is a cross-sectional view taken along a line XXVI-XXVI in FIG. 25.

FIG. 27 is a front view of a blowing device in a thirteenth embodiment.

FIG. 28 is a cross-sectional view taken along a line XXVIII-XXVIII in FIG. 27.

FIG. 29 is a cross-sectional view of a blowing device in a first comparative example.

FIG. 30 is a cross-sectional view of a blowing device in a second comparative example.

### DESCRIPTION OF EMBODIMENTS

To begin with, examples of relevant techniques will be described.

A device that supplies an added-value air, which is an air to which a predetermined value is added, with the vehicle cabin has been known. The added-value air may be a humidified air, an aroma air with scent, or a cool air for awakening a passenger.

The device includes a bypass passage in a middle of a duct that connects an air-conditioning unit to an air-conditioning outlet disposed in the vehicle cabin. The device takes a part of a conditioned air, as a main air, flowing through the duct and generates an added-value air including an electrostatic atomized water through the bypass passage. The added-value air is discharged out of the bypass passage into the duct, mixed with the conditioned air flowing through the duct, and blown into the vehicle cabin through the air-conditioning outlet. The added-value air including the electrostatic atomized water aims to sanitize and deodorize an air in the vehicle cabin, thus it is preferable that the added-value air is diffused widely in the vehicle cabin.

However, it is preferable that the added-value air such that a humidified air, an aroma air with scent, and a cooling air for awakening a passenger is discharged toward and supplied directly to the passenger through an outlet. As described above, the device in Patent Literature 1 is configured to blow the added-value air having being mixed with the conditioned air in the duct through the air-conditioning outlet, so that the device is not configured to discharge the added-value air directly to the passenger. Thus, if the device described in Patent Literature 1 blows the added-value air such as the humidified air or the aroma air into the vehicle cabin through the air-conditioning outlet, it is difficult for the added-value air to reach the passenger and thus an influence of the added-value air on the passenger may be reduced.

It is considered to define an outlet exclusive for the added-value air in an instrument panel of the vehicle as a means for supplying the added-value air directly to the passenger. However, recent interior design requirements make it difficult to define another outlet that has a different function from the air-conditioning outlet in the instrument panel of the vehicle.

It is objective of the present disclosure to provide a blowing device configured to separately blow a main air and an added-value air toward a passenger in a vehicle cabin.

According to an aspect of the present disclosure, a blowing device configured to blow an air into a vehicle cabin includes a divided region disposed to overlap with a portion of an air passage. The air passage is configured to blow a main air into a vehicle cabin. The divided region is configured to blow an added-value air that has an added value different from that of the main air toward a passenger separately from the main air.

Accordingly, since the added-value air is blown through the divided region disposed to overlap with a portion of the air passage configured to blow the main air into the vehicle cabin, the added-value air is restricted from being mixed with the main air. Thus, the added-value air is blown toward the passenger through the divided region of the air passage separately from the main air. Therefore, the blowing device enables the added-value air to be more likely to reach the passenger and an influence of the added-value air on the passenger can be improved.

The blowing device can blow the added-value air into the vehicle cabin with an existing outlet in the vehicle. Thus, it is needless to dispose an additional outlet through which the added-value air is blown out, so that the interior design requirements of the vehicle can be satisfied.

The main air is, for example, an air set to flow at a relatively large rate and may be a conditioned air blown from a vehicular air-conditioning unit, an air blown from a seat air-conditioning unit, or a conditioned air blown from a rear air-conditioning unit. In contrast, the added-value air is an air set to flow at a relatively smaller rate compared to the main air and may be a humidified air, an aroma air with scent, or a cool air for awakening a passenger.

Embodiments of the present disclosure will now be described with reference to the drawings. Parts that are identical or equivalent to each other in the following embodiments are assigned the same reference numerals and will not be described.

### First Embodiment

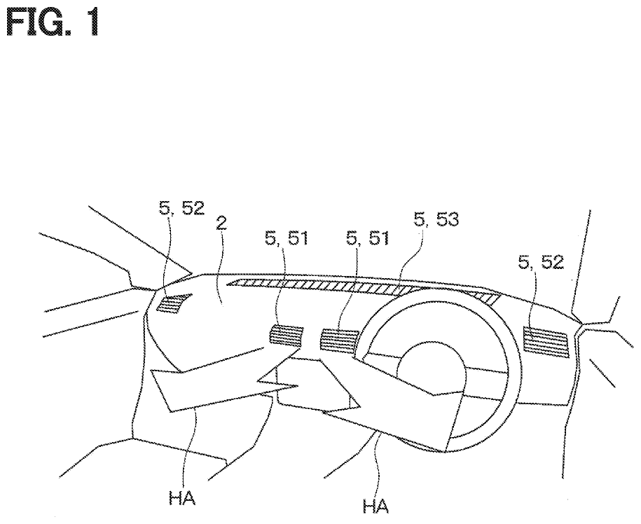

A first embodiment will be described with reference to FIGS. 1 to 3. A blowing device 1 in this embodiment is configured to separately blow a main air and an added-value air into a vehicle cabin. The added-value air is an air to which a predetermined value is added. The added-value air may be a humidified air, an aroma air with scent, or a cool air for awakening a passenger. In this embodiment, the added-value air is a humidified air.

At first, a configuration of the vehicle cabin of the vehicle in which the blowing device 1 is mounted will be described. As shown in FIGS. 1 and 2, an instrument panel 2 is disposed in a front side of the vehicle cabin. An air-conditioning unit 3 to condition an air in the vehicle cabin is mounted inside the instrument panel 2. The air-conditioning unit 3 may be referred to as a Heating Ventilation and Air Conditioning (HVAC) unit. An added-value air generating device 4 that is configured to generate the added-value air is disposed inside the instrument panel 2.

The instrument panel 2 defines multiple air-conditioning outlets 5 through which a conditioned air, as the main air, generated in the air-conditioning unit 3 is blown out into the vehicle cabin. Specifically, the multiple air-conditioning outlets 5 defined in the instrument panel 2 are constituted with center face grills 51, side face grills 52, and a defroster grill 53. The air-conditioning unit 3 and the multiple air-conditioning outlets 5 are connected to each other with multiple ducts 6. The conditioned air generated in the air-conditioning unit 3 is blown out through any of the multiple air-conditioning outlets 5 via the ducts 6.

The blowing device 1 in this embodiment is configured to blow a humidified air as the added-value air through the center face grills 51. In FIG. 1, the humidified air blown out through the center face grills 51 is shown by arrows HA.

A reason that the blowing device 1 in this embodiment blows the humidified air through the center face grills 51 will be described. When air-heating is performed in winter, in general, a foot outlet is mainly used as an outlet to supply a warm air into the vehicle cabin and the center face grills 51 are rarely used. In contrast, the humidified air is generally used in winter. Thus, by blowing the humidified air through the center face grills 51, the conditioned air as the main air and the humidified air as the added-value air can be separately supplied to the passenger.

In this embodiment, since the center face grills 51 that are ones of the existing air-conditioning outlets 5 in the vehicle are used, it is needless to dispose additional outlet for blowing the added-value air. Thus, it is possible to reduce an initial cost and improve a mountability of the vehicle while satisfying interior design requirements of the vehicle.

Next, a concrete configuration of the blowing device 1 in this embodiment will be described.

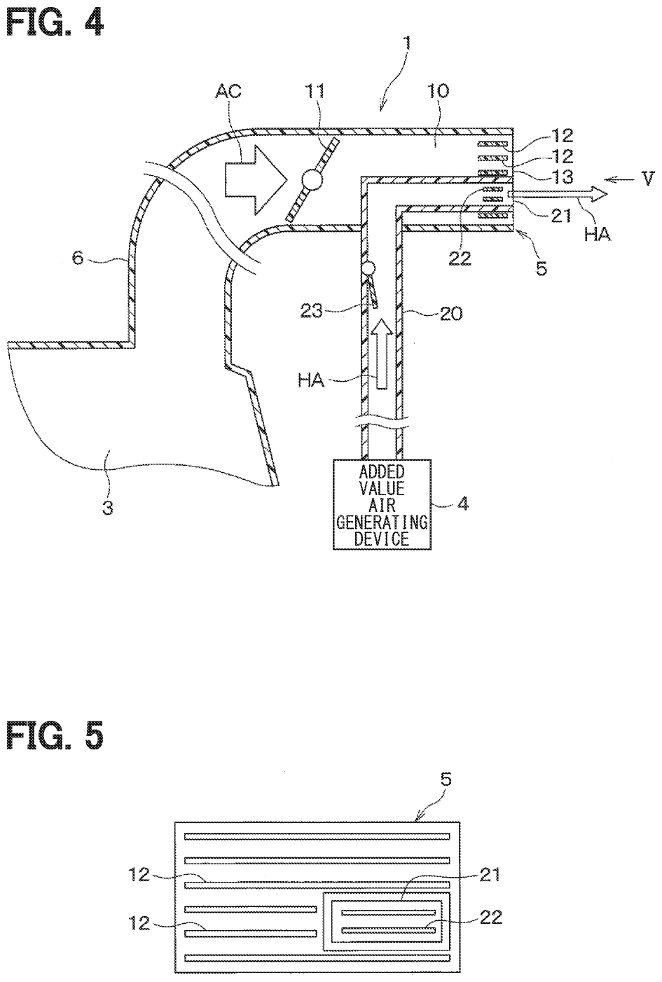

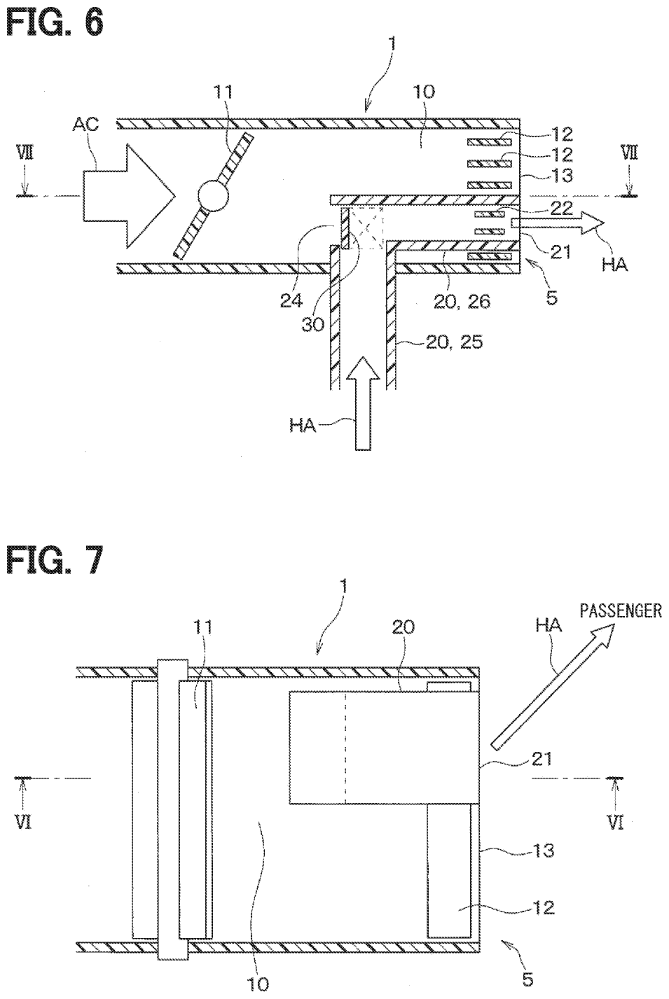

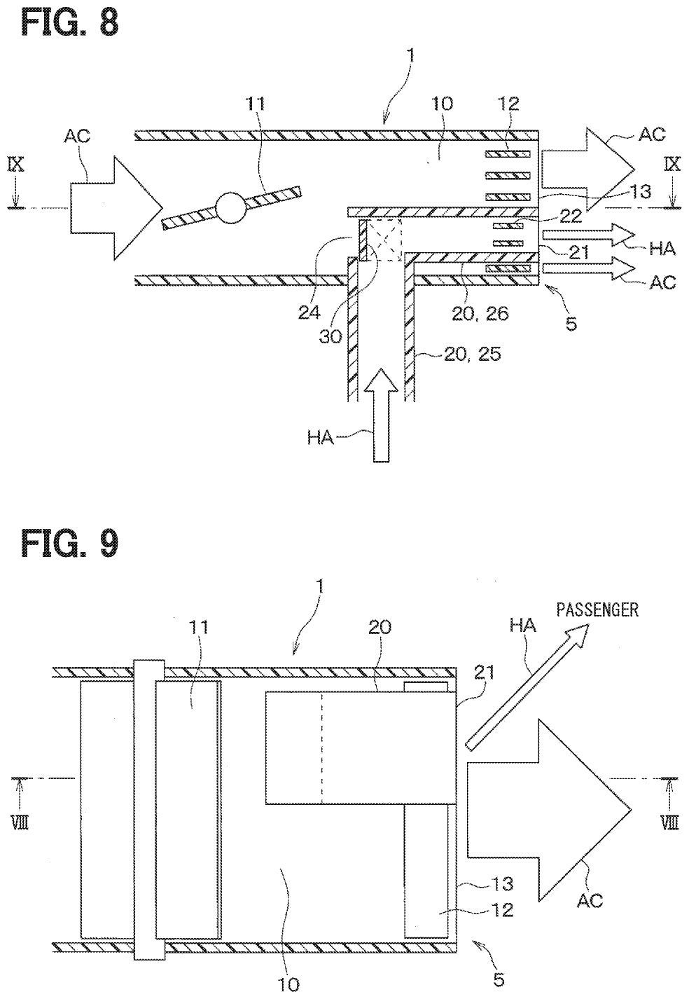

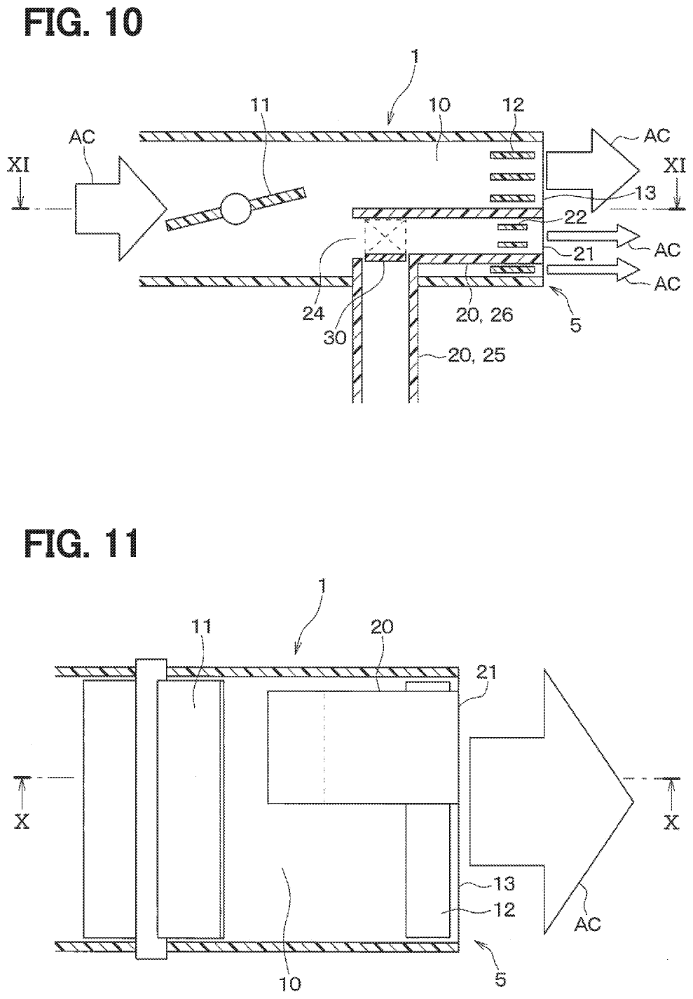

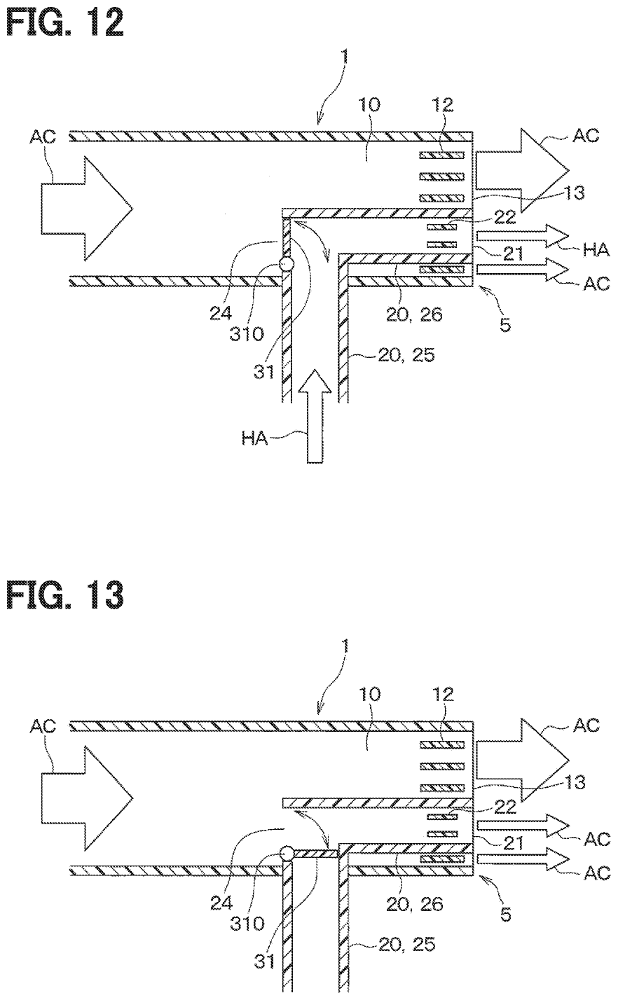

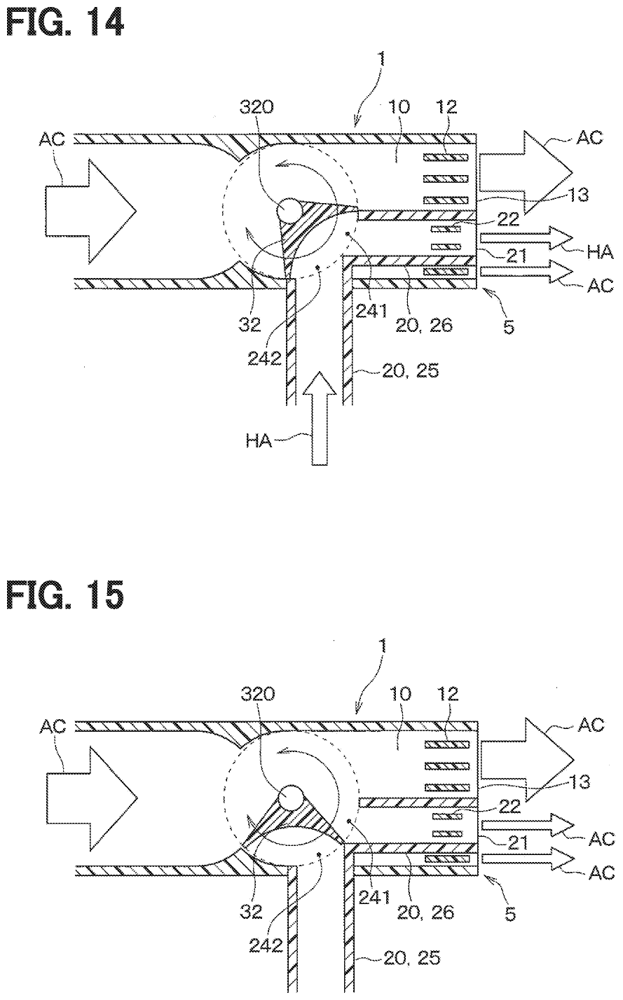

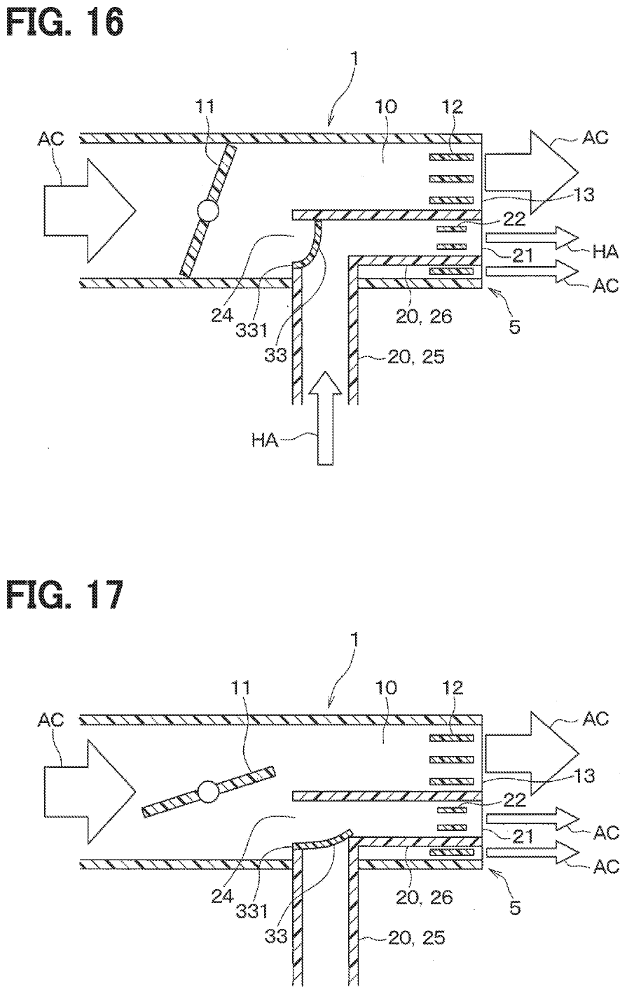

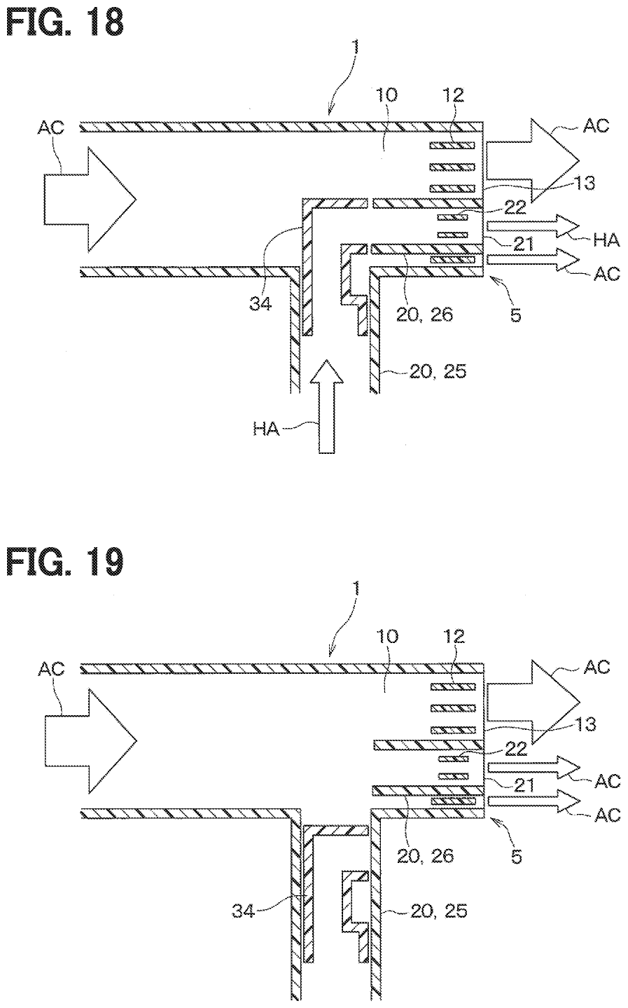

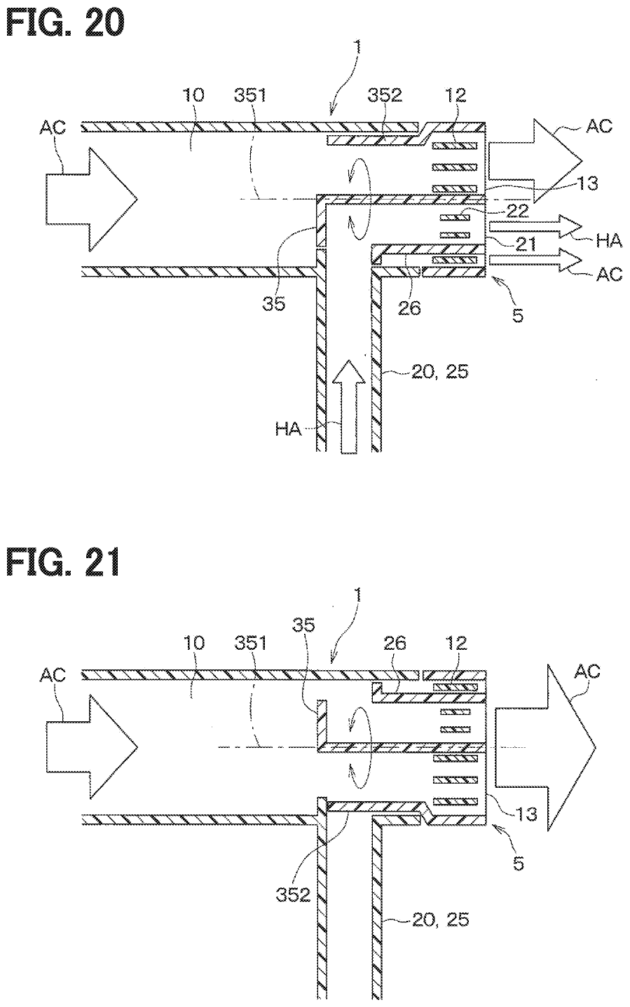

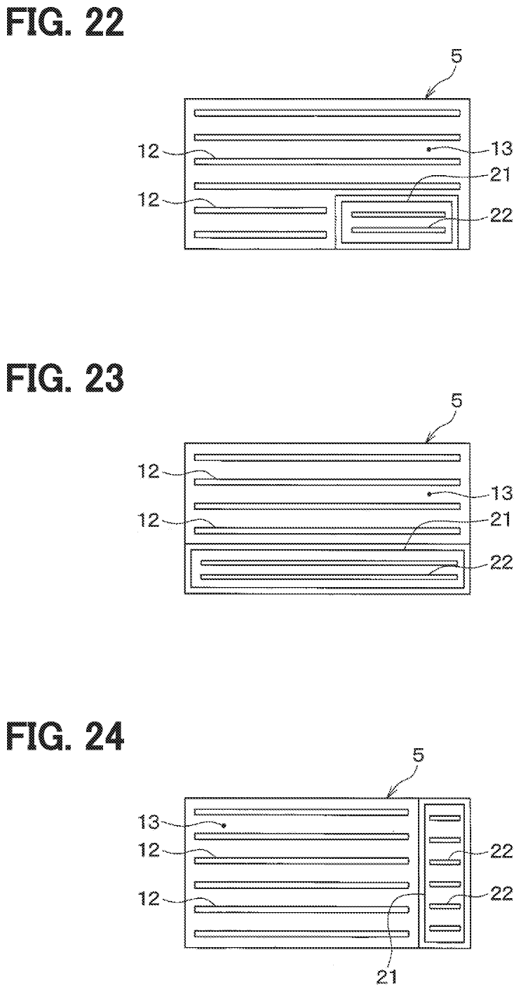

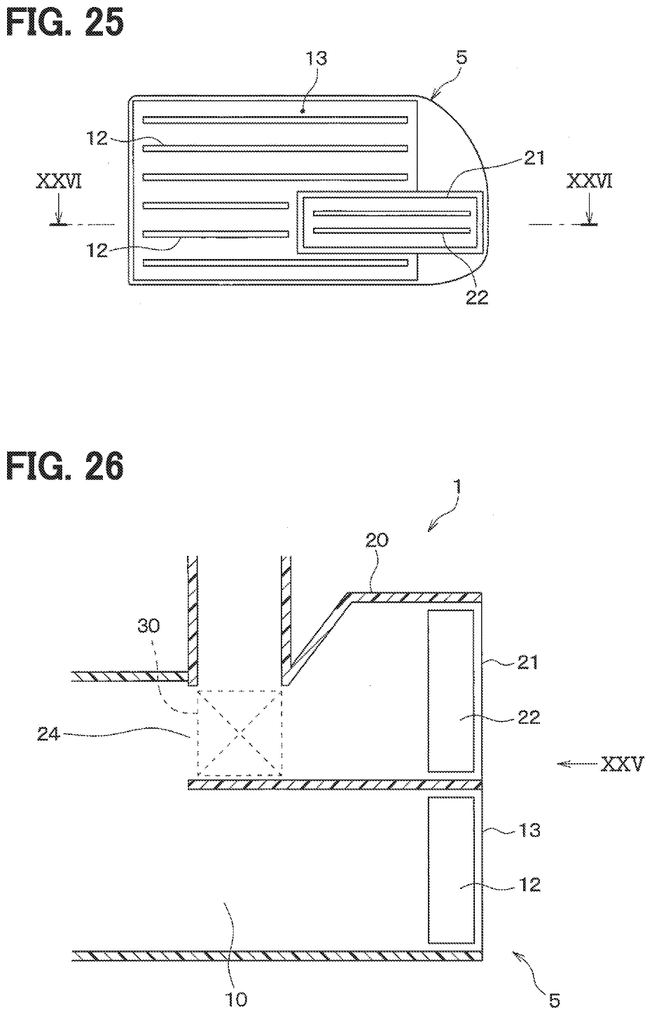

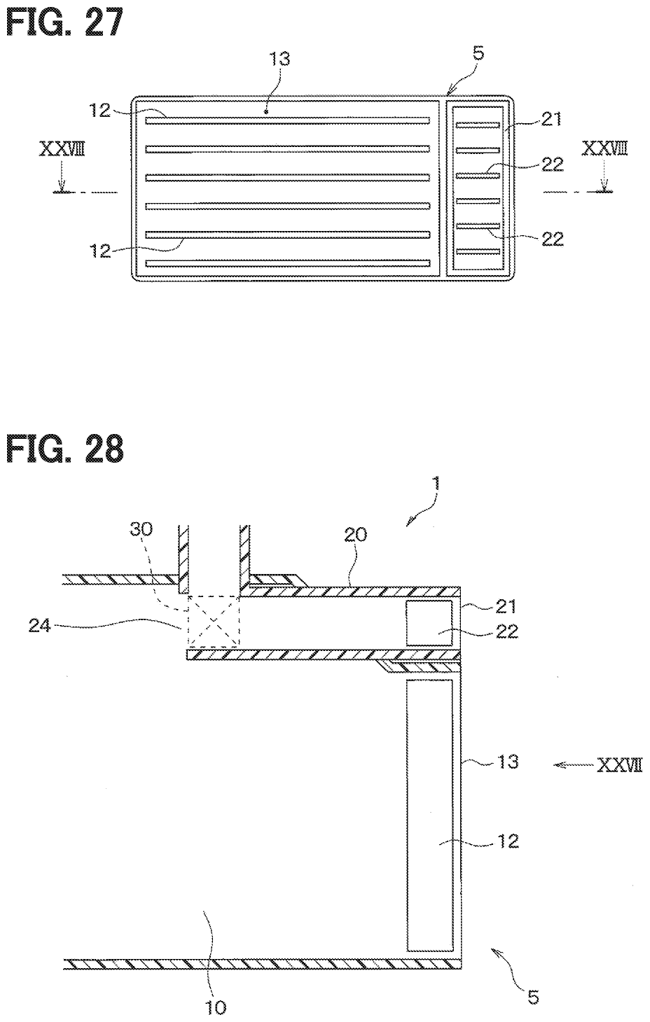

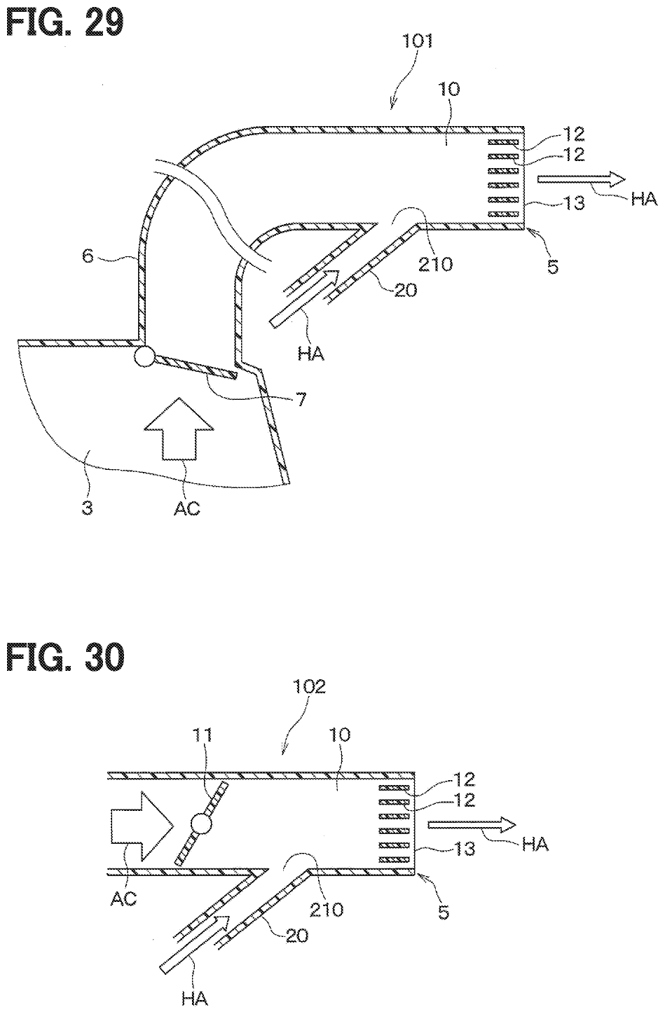

As shown in FIGS. 2 and 3, the blowing device 1 in this embodiment is disposed in an air passage 10 configured to blow a conditioned air as the main air into the vehicle cabin. The air passage 10 includes an air passage opening-closing valve 11, first airflow adjusting plates 12, and the like. The air passage opening-closing valve 11 is configured to adjust an area in the air passage 10 and may be a butterfly door. The first airflow adjusting plates 12 are disposed in a vicinity of an blowing opening surface 13 of the air passage 10 that opens to the vehicle cabin. The first airflow adjusting plates 12 are not limited to ones extending in a vehicle width direction as shown in figures and may be ones extending in a vertical direction or ones formed into a grid pattern. A direction in which the conditioned air is blown into the vehicle cabin from the air passage 10 can be adjusted by adjusting angles of the first airflow adjusting plates 12.

The blowing device 1 includes a passage member 20 configured to introduce the humidified air generated in the added-value air generating device 4 into the air passage 10. The passage member 20 is inserted into the air passage 10 from an outside of a wall of the air passage 10 and is configured to blow out the humidified air through a passage opening portion 21 disposed inside the air passage 10.

The passage opening portion 21 of the passage member 20 corresponds to a divided region configured to blow the humidified air, as the added-value air, toward the passenger separately from the conditioned air as the main air. Thus, the blowing device 1 in this embodiment includes the divided region disposed to overlap with a portion of the air passage 10. The passage opening portion 21 (i.e., the divided region) of the passage member 20 has an area corresponding to a flow rate of the humidified air blown out of the passage opening portion 21 such that the humidified air can reach the passenger. It is preferable to dispose the passage opening portion 21 in a vicinity of the first airflow adjusting plates 12.

Second airflow adjusting plates 22 are disposed in the passage opening portion 21. The second airflow adjusting plates 22 are not limited to ones extending in the vehicle width direction as shown in figures and may be ones extending in the vertical direction or may be ones formed into a grid pattern. The second airflow adjusting plates 22 have angles such that the humidified air can be blown to the passenger through an opening of the passage member 20. The passage member 20 includes a passage opening-closing valve 23 therein. The passage opening-closing valve 23 is configured to adjust an area inside the passage member 20 and may be a cantilever type door.

Next, an operation of the blowing device 1 in this embodiment will be described.

FIG. 2 is a schematic view illustrating a state in which the air passage opening-closing valve 11 is closed and the passage opening-closing valve 23 is opened. In this case, as shown in arrows HA, the humidified air generated in the added-value air generating device 4 flows through the passage member 20 and the passage opening portion 21 and is blown out toward the passenger through the blowing opening surface 13 of the air passage 10. In contrast, the conditioned air as shown in an arrow AC is not blown out through the blowing opening surface 13 of the air passage 10. Thus, the humidified air is supplied to the passenger separately from the conditioned air. As described above, the passage opening portion 21 of the passage member 20 has a predetermined area corresponding to a flow rate of the humidified air and is disposed in a vicinity of the first airflow adjusting plates 12. Thus, the humidified air is supplied to the passenger at an appropriate flow rate.

In contrast, when the air passage opening-closing valve 11 is opened, the conditioned air generated in the air-conditioning unit 3 flows through the air passage 10 and is blown out through the blowing opening surface 13 into the vehicle cabin, which are not shown. Also in this case, as described above, the passage opening portion 21 of the passage member 20 has the predetermined area corresponding to a flow rate of the humidified air and is disposed in the vicinity of the first airflow adjusting plates 12. Thus, the humidified air is restricted from being mixed with the conditioned air. Therefore, the humidified air is supplied to the passenger at an appropriate flow rate separately from the conditioned air.

The blowing device 1 in this embodiment as described above has the following advantages.

(1) The blowing device 1 in this embodiment includes the passage opening portion 21 serving as the divided region and the passage opening portion 21 is disposed to overlap with a portion of the air passage 10. The divided region is configured to blow the humidified air to the passenger separately from the conditioned air. As a result, the humidified air is restricted from being mixed with the conditioned air and can be blown to the passenger separately from the conditioned air. Thus, the blowing device 1 can improve a reachability of the humidified air to the passenger and increase an influence of the humidified air on the passenger.

(2) The air passage 10 in which the blowing device 1 in this embodiment is disposed is configured to blow the conditioned air, which is generated in the air-conditioning unit 3, as the main air into the vehicle cabin. Accordingly, the blowing device 1 is configured to blow the humidified air into the vehicle cabin with the air-conditioning outlets 5 that are existing in the vehicle. Thus, it is needless to dispose an additional outlet for blowing the humidified air, so that the interior design requirements in the vehicle can be satisfied.

(3) The blowing device 1 in this embodiment includes the passage member 20 that is inserted into the air passage 10 from an outside of the wall of the air passage 10. The passage member 20 is configured to blow the humidified air through the passage opening portion 21 that has a predetermined opening area. Accordingly, the blowing device 1 can blow the humidified air flowing through the passage member 20 into the vehicle cabin through the passage opening portion 21 separately from the conditioned air.

(4) The blowing device 1 in this embodiment includes the first airflow adjusting plates 12 disposed in the air passage 10 and the second airflow adjusting plates 22 disposed in the passage opening portion 21 of the passage member 20. Accordingly, the blowing device 1 can separately adjust a direction in which the conditioned air is blown into the vehicle cabin and a direction in which the humidified air is blown into the vehicle cabin by adjusting the first airflow adjusting plates 12 and the second airflow adjusting plates 22.

### First and Second Comparative Examples

To compare with the blowing device 1 in this embodiment described above, blowing devices in comparative examples will be described. FIG. 29 is a view illustrating a blowing device 101 in a first comparative example and FIG. 30 is a view illustrating a blowing device 102 in a second comparative example.

Each of the blowing devices in the first comparative example and the second comparative example has a passage opening portion 210 of a passage member 20. The passage opening portion 210 is located in a part of an inner wall of the air passage 10 through which the conditioned air generated in the air-conditioning unit 3. Thus, the humidified air flowing through the passage member 20 flows into the air passage 10 through the passage opening portion 210 and then is blown out through the blowing opening surface 13 of the air passage 10 into the vehicle cabin. In general, the blowing opening surface 13 of the air passage 10 to blow the conditioned air has a very large area against a flow rate of the humidified air flowing through the passage member 20. Therefore, when the humidified air is blown through the blowing opening surface 13 of the air passage 10, a flow velocity of the humidified air is reduced and thereby the humidified air may not reach the passenger.

In the first comparative example and the second comparative example, when the conditioned air and the humidified air are blown out at a same timing by opening a face door 7 of the air-conditioning unit 3 or the air passage opening-closing valve 11, the humidified air flowing into the air passage 10 through the passage opening portion 21 of the passage member 20 is mixed with the conditioned air flowing through the air passage 10. Thus, the humidified air is not directly blown to the passenger and an influence of the humidified air on the passenger may be reduced.

In contrast, in the blowing device 1 in this embodiment as described above, the humidified air is blown to the passenger separately from the conditioned air and reach the passenger at an appropriate flow rate. Thus, the blowing device 1 in the first embodiment can improve a reachability of the humidified air to the passenger and increase an influence of the humidified air on the passenger.

### Second Embodiment

A second embodiment will be described. The second embodiment is different from the first embodiment at a position of the passage opening portion 21 (i.e., the divided region) of the passage member 20. Other portions are similar to the first embodiment, thus different portions from the first embodiment will be mainly described.

As shown in FIGS. 4 and 5, in the second embodiment, the passage opening portion 21 of the passage member 20 is disposed to overlap with a portion of the blowing opening surface 13 of the air passage 10 that opens to the vehicle cabin. The passage opening portion 21 has an area corresponding to a flow rate of the humidified air such that the humidified air blown out through the passage opening portion 21 reaches the passenger.

In the second embodiment, the passage opening portion 21 (i.e., the divided region) is disposed to overlap with the portion of the blowing opening surface 13 of the air passage 10, so that the humidified air is restricted from being mixed with the conditioned air. Thus, the humidified air is blown to the passenger separately from the conditioned air. As a result, the blowing device 1 can improve a reachability of the humidified air to the passenger and increase an influence of the humidified air on the passenger.

The second embodiment can obtain similar advantages as the first embodiment.

### Third Embodiment

A third embodiment will be described. The third embodiment is different from the first embodiment at a point that the passage member 20 has a passage switching device 30 and other portions are similar to the first embodiment. Thus, different portions from the first embodiment will be mainly described.

As shown in FIGS. 6, 8, and 10, in the third embodiment, the passage member 20 defines a hole portion 24 in a portion of the passage member 20 that is located in the air passage 10. The hole portion 24 is located in a side of the passage member 20 opposite to the passage opening portion 21. In the third embodiment, a passage switching device 30 is disposed inside of the passage member 20. The passage switching device 30 is configured to switch between a first state in which the humidified air is blown out through the passage opening portion 21 of the passage member 20 and a second state in which the conditioned air is blown out through an entire of the blowing opening surface 13 of the air passage 10.

The passage member 20 includes an inside passage member 26 that is located inside of the air passage 10 and that extends from the hole portion 24 to the passage opening portion 21 and an outside passage member 25 that is located outside of the air passage 10 and that extends outward from the hole portion 24.

In FIGS. 6 and 7, the passage switching device 30 forms the first state. In this case, the passage switching device 30 closes the hole portion 24 of the passage member 20 and allows the humidified air to flow into the inside passage member 26 from the outside passage member 25. Thus, as shown in arrows HA, the humidified air flowing through the passage member 20 is blown out to the passenger through the passage opening portion 21. In FIGS. 6 and 7, the air passage opening-closing valve 11 is closed. Thus, the conditioned air is not blown out through a region of the blowing opening surface 13 of the air passage 10 other than the passage opening portion 21.

In FIGS. 8 and 9, the passage switching device 30 forms the first state. Thus, as shown in arrows HA, the humidified air is blown to the passenger through the passage opening portion 21 that is disposed in the blowing opening surface 13 of the air passage 10. In FIGS. 8 and 9, the air passage opening-closing valve 11 is opened. Thus, as shown in arrows AC, the conditioned air is blown out through the region of the blowing opening surface 13 of the air passage 10 other than the passage opening portion 21. Also in this case, the humidified air is restricted from being mixed with the conditioned air, so that the humidified air is blown toward the passenger separately from the conditioned air.

In FIGS. 10 and 11, the passage switching device 30 forms the second state. In this case, the passage switching device 30 opens the hole portion 24 of the passage member 20 to the air passage 10 and prohibits the humidified air from flowing into the inside passage member 26 from the outside passage member 25. In FIGS. 10 and 11, the air passage opening-closing valve 11 is opened. Thus, the conditioned air flowing through the air passage 10 flows both outside of the inside passage member 26 and inside of the inside passage member 26 through the hole portion 24. That is, as shown in arrows AC, the conditioned air is blown out into the vehicle cabin through an entire of the blowing opening surface 13 of the air passage 10. Therefore, the air-conditioning unit 3 can perform an air-conditioning in the vehicle cabin without decreasing a flow rate of the conditioned air.

The blowing device 1 in the third embodiment described above blows the humidified air to the passenger separately from the conditioned air by setting the passage switching device 30 in the first state. As a result, the humidified air is more likely to reach the passenger. The blowing device 1 blows the conditioned air into the vehicle cabin through the entire of the blowing opening surface 13 of the air passage 10 by setting the passage switching device 30 in the second state. Thus, the air-conditioning in the vehicle cabin can be performed without decreasing a flow rate of the conditioned air. Therefore, the blowing device 1 can improve both an influence of the humidified air on the passenger and a comfort of the passenger with the air-conditioning in the vehicle cabin by operating the passage switching device 30.

### Fourth to Eighth Embodiments

Fourth to eighth embodiments which will be described below exemplify specific configurations of the passage switching device 30 in the third embodiment.

### Fourth Embodiment

The fourth embodiment will be described with reference to FIGS. 12 and 13. The passage switching device in the fourth embodiment is a damper 31 configured to selectively open and close the hole portion 24 of the passage member 20. The damper 31 is rotatably disposed around a rotational axis 310 that is located in a vicinity of the hole portion 24 of the passage member 20. The damper 31 closes the hole portion 24 of the passage member 20 in the first state and fluidly connects the hole portion 24 of the passage member 20 to the air passage 10 in the second state. The damper 31 is driven manually or by an actuator (not shown).

In FIG. 12, the damper 31 forms the first state. In this case, the damper 31 closes the hole portion 24 of the passage member 20 and allows the humidified air to flow into the inside passage member 26 from the outside passage member 25. As shown in arrows HA, the humidified air flowing through the passage member 20 is blown out to the passenger through the passage opening portion 21. In FIG. 12, as shown in arrows AC, the conditioned air is blown out through the region of the blowing opening surface 13 of the air passage 10 other than the passage opening portion 21. Also in this case, the humidified air is restricted from being mixed with the conditioned air, so that the humidified air can reach the passenger separately from the conditioned air.

In FIG. 13, the damper 31 forms the second state. In this case, the damper 31 opens the hole portion 24 of the passage member 20 to the air passage 10 and closes the outside passage member 25. Thus, the humidified air is prohibited from flowing into the inside passage member 26 from the outside passage member 25. The conditioned air flowing through the air passage 10 flows both outside and inside of the inside passage member 26. Therefore, as shown in arrows AC, the conditioned air is blown out into the vehicle cabin through the entire of the blowing opening surface 13 of the air passage 10. As a result, the air-conditioning unit 3 can perform an air-conditioning in the vehicle cabin without reducing a flow rate of the conditioned air.

### Fifth Embodiment

A fifth embodiment will be described with reference to FIGS. 14 and 15. The passage switching device in the fifth embodiment is a rotary door 32 configured to selectively open and close a first hole portion 241 of the inside passage member 26 and a second hole portion 242 of the outside passage member 25. The rotary door 32 is disposed rotatably around a rotational axis 320 that is located in a vicinity of the first hole portion 241 and the second hole portion 242 of the passage member 20. The rotary door 32 is driven manually or by an actuator (not shown).

As shown in FIG. 14, the rotary door 32 fluidly separates the first hole portion 241 and the second hole portion 242 from the air passage 10 and allows the humidified air to flow into the inside passage member 26 from the outside passage member 25 in the first state. In this case, as shown in arrows HA, the humidified air flowing through the passage member 20 is blown to the passenger through the passage opening portion 21. As shown in arrows AC, the conditioned air is blown out through the region of the blowing opening surface 13 of the air passage 10 other than the passage opening portion 21. The humidified air is restricted from being mixed with the conditioned air, so that the humidified air is supplied to the passenger separately from the conditioned air.

As shown in FIG. 15, the rotary door 32 opens the first hole portion 241 of the inside passage member 26 to the air passage 10 and closes the second hole portion 242 of the outside passage member 25 in the second state. Thus, the conditioned air flowing through the air passage 10 flows both outside and inside of the inside passage member 26. As shown in arrows AC, the conditioned air is blown into the vehicle cabin through the entire of the blowing opening surface 13 of the air passage 10. As a result, the air-conditioning unit 3 can perform the air-conditioning in the vehicle cabin without decreasing a flow rate of the conditioned air.

### Sixth Embodiment

A sixth embodiment will be described with reference to FIGS. 16 and 17. The passage switching device in the sixth embodiment is a check valve 33 disposed in the hole portion 24 of the passage member 20. The check valve 33 is made of, for example, a non-woven fabric. The check valve 33 has an end 331 fixed to an inner wall of the hole portion 24. The check valve 33 is driven by a pressure difference between the passage member 20 and the air passage 10 and configured to selectively open and close the hole portion 24 of the passage member 20.

In FIG. 16, the air passage opening-closing valve 11 is closed. In this case, a pressure of the humidified air flowing through the passage member 20 is larger than a pressure in the air passage 10. Thus, the check valve 33 closes the hole portion 24 of the passage member 20 and allows the humidified air to flow into the inside passage member 26 from the outside passage member 25 in the first state. In this case, as shown in arrows HA, the humidified air flowing through the passage member 20 is blown out to the passenger through the passage opening portion 21.

In FIG. 17, the air passage opening-closing valve 11 is opened. In this case, a pressure of air flowing through the air passage 10 is larger than a pressure in the passage member 20. Thus, the check valve 33 opens the hole portion 24 of the passage member 20 to the air passage 10 and closes the outside passage member 25 in the second state. The conditioned air flowing through the air passage 10 flows both outside and inside of the inside passage member 26 and, as shown in arrows AC, the conditioned air is blown into the vehicle cabin through the entire of the blowing opening surface 13 of the air passage 10. Therefore, the air-conditioning unit 3 can perform an air-conditioning without decreasing a flow rate of the conditioned air.

### Seventh Embodiment

A seventh embodiment will be described with reference to FIGS. 18 and 19. The passage switching device in the seventh embodiment is a reciprocating body 34 that is configured to reciprocably move along the outside passage member 25. The reciprocating body 34 protrudes from the outside passage member 25 into the air passage 10 in the first state to fluidly connect the outside passage member 25 to the inside passage member 26. The reciprocating body 34 draws back into the outside passage member 25 in the second state to fluidly separate the outside passage member 25 from the air passage 10. The reciprocating body 34 is driven manually or by an actuator (not shown).

In FIG. 18, the reciprocating body 34 forms the first state. In this case, the reciprocating body 34 fluidly connects the outside passage member 25 to the inside passage member 26 to allow the humidified air to flow from the outside passage member 25 into the inside passage member 26. The reciprocating body 34 prohibits the conditioned air from flowing into the inside passage member 26 from the air passage 10. Thus, as shown in arrows HA, the humidified air flowing through the passage member 20 is blown out to the passenger through the passage opening portion 21. In FIG. 18, as shown in arrows AC, the conditioned air is blown out through the region of the blowing opening surface 13 of the air passage 10 other than the passage opening portion 21. Also in this case, the humidified air is restricted from being mixed with the conditioned air, so that the humidified air is blown to the passenger separately from the conditioned air.

In FIG. 19, the reciprocating body 34 forms the second state. In this case, the reciprocating body 34 draws back into the outside passage member 25 to fluidly separate the outside passage member 25 from the air passage 10. In a same time, the reciprocating body 34 allows the conditioned air to flow into the inside passage member 26 from the air passage 10. Thus, the conditioned air flowing through the air passage 10 flows both outside and inside of the inside passage member 26. Thus, as shown in arrows AC, the conditioned air is blown into the vehicle cabin through the entire of the blowing opening surface 13 of the air passage 10. As a result, the air-conditioning unit 3 can perform an air-conditioning in the vehicle cabin without decreasing a flow rate of the conditioned air.

### Eighth Embodiment

An eighth embodiment will be described with reference to FIGS. 20 and 21. The passage switching member in the eighth embodiment is a rotating member 35 that is rotatably disposed in the air passage 10. The rotating member 35 rotates around a rotational axis shown in a dashed dot line 351 in FIGS. 20 and 21. The passage member includes the outside passage member 25 and the rotating member 35. The rotating member 35 includes the inside passage member 26 and a wall 352. The inside passage member 26 defines, in the blowing opening surface of the air passage, the passage opening portion 21. The rotating member 35 rotates manually or by an actuator (not shown).

In FIG. 20, the rotating member 35 forms the first state. In this case, the inside passage member 26 that constitutes a part of the rotating member 35 is fluidly connected to the outside passage member 25, so that the outside passage member 25 is fluidly connected to the passage opening portion 21 through the inside passage member 26. The rotating member 35 prohibits the conditioned air from flowing into the inside passage member 26 from the air passage 10 by the inside passage member 26. Thus, as shown in arrows HA, the humidified air is allowed to flow into the inside passage member 26 from the outside passage member 25. The humidified air flowing through the passage member 20 is blown out to the passenger through the passage opening portion 21. In FIG. 20, as shown in arrows AC, the conditioned air is blown out through the region of the blowing opening surface 13 of the air passage 10 other than the passage opening portion 21. Also in this case, the humidified air is restricted from being mixed with the conditioned air, so that the humidified air is supplied to the passenger separately from the conditioned air.

In FIG. 21, the rotating member 35 forms the second state. In this case, the rotating member 35 closes the outside passage member 25 by the wall 352 and fluidly connects the air passage 10 to the entire region of the blowing opening surface 13 of the air passage 10. Thus, as shown in arrows AC, the conditioned air flowing through the air passage 10 is blown into the vehicle cabin through the entire region of the blowing opening surface 13 of the air passage 10. As a result, the air-conditioning unit 3 can perform the air-conditioning in the vehicle cabin without decreasing a flow rate of the conditioned air.

### Ninth to Thirteenth Embodiments

Ninth to thirteenth embodiments which will be described below differ from the first embodiment at a position of the passage opening portion 21 (i.e., the divided region) of the passage member 20. Other portions are similar to the first embodiment and different portions from the first embodiment will be mainly described.

As shown in FIGS. 22 to 28, in the ninth to thirteenth embodiments, the passage opening portion 21 of the passage member 20 is disposed to overlap with a portion of the blowing opening surface 13 of the air passage 10 that opens to the vehicle cabin as with the second embodiment. The passage opening portion 21 has an area corresponding to a flow rate of the humidified air such that the humidified air blown out through the passage opening portion 21 reaches the passenger. Hereinafter, the ninth to thirteenth embodiments will be concretely described.

### Ninth Embodiment

As shown in FIG. 22, in the ninth embodiment, the passage opening portion 21 (i.e., the divided region) is in contact with one side of an outer frame of the blowing opening surface 13 of the air passage 10. Specifically, the passage opening portion 21 of the passage member 20 is in contact with a part of a lower side of the blowing opening surface 13 of the air passage 10.

As modifications of the ninth embodiment, the passage opening portion 21 of the passage member 20 may be in contact with a part of an upper side, a left side, or a right side of the blowing opening surface 13 of the air passage 10.

The ninth embodiment and its modifications can obtain similar advantages with the first embodiment.

### Tenth Embodiment

As shown in FIG. 23, in the tenth embodiment, the passage opening portion 21 of the passage member 20 is in contact with an entire of one side forming the outer frame of the blowing opening surface 13 of the air passage 10. Specifically, the passage opening portion 21 of the passage member 20 is in contact with an entire of the lower side of the blowing opening surface 13 of the air passage 10.

As a modification of the tenth embodiment, the passage opening portion 21 of the passage member 20 may be in contact with an entire of the upper side of the blowing opening surface 13 of the air passage 10.

The tenth embodiment and its modification can obtain similar advantages with the first embodiment described above.

### Eleventh Embodiment

As shown in FIG. 24, in the eleventh embodiment, the passage opening portion 21 of the passage member 20 is in contact with an entire of one side forming the outer frame of the blowing opening surface 13 of the air passage 10. Specifically, the passage opening portion 21 of the passage member 20 is in contact with an entire of the right side of the blowing opening surface 13 of the air passage 10.

As a modification of the eleventh embodiment, the passage opening portion 21 of the passage member 20 may be in contact with an entire of the left side of the blowing opening surface 13 of the air passage 10.

The eleventh embodiment and its modification can obtain similar advantages with the first embodiment.

### Twelfth Embodiment

As shown in FIGS. 25 and 26, in the twelfth embodiment, a part of the passage opening portion 21 of the passage member 20 protrudes from the blowing opening surface 13 of the air passage 10. The blowing opening surface 13 of the air passage 10 and the passage opening portion 21 of the passage member 20 can be designed as a single air-conditioning outlet 5 that is disposed in the instrument panel 2.

As shown in FIG. 26, the passage switching device 30 is disposed in the passage member 20. As described in the third embodiment, the passage switching device 30 is configured to switch between the first state in which the humidified air is blown through the passage opening portion 21 of the passage member 20 and the second state in which the conditioned air is blown out through the entire region of the blowing opening surface 13 of the air passage 10.

As modifications of the twelfth embodiment, a part of the passage opening portion 21 of the passage member 20 may protrude leftward, upward, or downward from the outlet opening portion 21 of the passage member 20.

The eleventh embodiment and its modifications can obtain similar advantages with the first embodiment.

### Thirteenth Embodiment

As shown in FIGS. 27 and 28, in the thirteenth embodiment, the blowing opening surface 13 of the air passage 10 and the passage opening portion 21 of the passage member 20 are arranged side by side. The blowing opening surface 13 of the air passage 10 and the passage opening portion 21 of the passage member 20 can be designed as a single air-conditioning outlet 5 that is disposed in the instrument panel 2.

As shown in FIG. 28, the passage switching device 30 is disposed in the passage member 20. As described in the third embodiment, the passage switching device 30 is configured to switch between the first state in which the humidified air is blown out through the passage opening portion 21 of the passage member 20 and the second state in which the conditioned air is blown out through the entire region of the blowing opening surface 13 of the air passage 10.

As modifications of the thirteenth embodiment, the passage opening portion 21 of the passage member 20 may be arranged in a left side, upper side, or lower side of the blowing opening surface 13 of the air passage 10.

The thirteenth embodiment and its modifications can obtain similar advantages with the first embodiment.

### Other Embodiments

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

(1) The blowing device 1 in the embodiments described above is configured to blow out the added-value air through the air-conditioning outlet 5, but the present disclosure is not limited to this. The blowing device 1 may be configured to blow the added-value air through the seat air-conditioning outlet or the rear air-conditioning outlet.

(2) The blowing device 1 in the embodiments described above is configured to blow the added-value air through the center face grills 51, but the present disclosure is not limited to this. The blowing device 1 may be configured to blow the added-value air through the side face grills 52.

(3) The blowing device 1 in the embodiments described above is configured to blow the humidified air as the added-value air, but the present disclosure is not limited to this. The blowing device 1 may be configured to blow an aroma air with scent or cool air for awakening the passenger as the added-value air.

(Overview)

According to a first aspect described in a part or all parts of the embodiments described above, a blowing device is configured to blow an air into a vehicle cabin. The blowing device includes a divided region that overlaps with a portion of an air passage configured to blow a main air into the vehicle cabin. The divided region is configured to blow an added-value air that has an added-value different from that of the main air separately from the main air.

According to a second aspect, the divided region is disposed to overlap with an blowing opening surface of the air passage that opens to the vehicle cabin. Since the divided region is disposed in the blowing opening surface of the air passage, the added-value air is restricted from being mixed with the main air. Thus, the added-value air is blown to the passenger through the divided region separately from the main air. As a result, the blowing device can improve a reachability of the added-value air to the passenger and increase influence of the added-value on the passenger.

The blowing device can blow the added-value air into the vehicle cabin with the air passage disposed in the vehicle cabin. Since an additional outlet for blowing the added-value air is not needed in the vehicle cabin, the interior design requirements can be satisfied. According to a third aspect, the air passage is configured to blow a conditioned air, as the main air, for conditioning an air in the vehicle cabin that is generated in an air-conditioning unit. The blowing device can blow the added-value air into the vehicle cabin with an air-conditioning outlet that is existing for blowing the conditioned air of the air-conditioning unit into the vehicle cabin. Since an additional outlet for blowing the added-value air is not needed in the vehicle cabin, the interior design requirements can be satisfied.

According to a fourth aspect, the blowing device has a passage member that is inserted into the air passage from an outside of a wall of the air passage. The passage member is configured to blow the added-value air through the passage opening portion serving as the divided region. Thus, the blowing device can blow the added-value air flowing through the passage member into the vehicle cabin separately from the main air flowing through the air passage.

According to a fifth aspect, the blowing device includes a first airflow adjusting plate disposed in the air passage and a second airflow adjusting plate disposed in the passage opening portion of the passage member. Thus, the blowing device can separately adjust a direction in which the main air is blown into the vehicle cabin and a direction in which the added-value air is blown into the vehicle cabin by adjusting the first airflow adjusting plate and the second airflow adjusting plate.

According to a sixth aspect, the blowing device further includes a passage switching device. The passage switching device is configured to switch between a first state in which the added-value air is blown out through the divided region and a second state in which the main air is blown out through both the divided region and a region of the air passage other than the divided region. Thus, by setting the passage switching device in the first state, the added-value air is blown out through the divided region to the passenger separately from the main air. As a result, the added-value air is more likely to reach the passenger.

By setting the passage switching device in the second state, the main air is blown into the vehicle cabin thorough an entire region of the blowing opening surface of the air passage. Thus, the air-conditioning in the vehicle cabin is performed without decreasing a flow rate of the conditioned air as the main air. As a result, the blowing device can improve both an influence of the added-value air on the passenger and a comfort for the passenger with the air-conditioning in the vehicle cabin by operating the passage switching device.

The blowing device can blow the added-value air through the divided region and the main air through a region of the air passage other than the divided region at the same timing by setting the passage switching device in the first state.

According to a seventh aspect, the passage member defines a hole portion in a portion of the passage member that is located in the air passage. The passage switching device is a damper or a rotary door each of which is configured to selectively open and close the hole portion of the passage member. The damper closes the hole portion of the passage member in the first state and fluidly connects the hole portion of the passage member to the air passage in the second state. Thus, the damper or the rotary door each of which selectively opens and closes the hole portion of the passage member is exemplified as the passage switching device.

According to an eighth embodiment, the passage member includes a hole portion in a portion of the passage member that is located in the air passage. The passage switching device is a check valve disposed in the hole portion. The check valve prohibits the added-value air flowing through the passage member from flowing into the air passage through the hole portion in the first state and allows the main air flowing through the air passage to flow into the passage member through the hole portion in the second state. Thus, the check valve disposed in the hole portion of the passage member is exemplified as the passage switching device.

According to a ninth embodiment, the passage member includes an outside passage member that is disposed outside of the air passage and an inside passage member that is disposed inside of the air passage. The passage switching device is a reciprocating body that is configured to reciprocably move along the outside passage member. The reciprocating body is configured to protrude from the outside passage member into the air passage in the first state to fluidly connect the outside passage member to the inside passage member and draw back into the outside passage member in the second state. Thus, the reciprocating body configured to reciprocably move along the outside passage member is exemplified as the passage switching device.

According to a tenth aspect, the passage member includes the outside passage member and the rotating member that is rotatably disposed in the air passage. The rotating member includes the inside passage member and the wall. The rotating member is configured to fluidly connect the outside passage member to the divided region and fluidly separate the air passage from the divided region in the first state. The rotating member is configured to fluidly separate the outside passage member from the divided region and fluidly connects the air passage to the divided region in the second state. Thus, the rotating member disposed rotatably in the air passage is exemplified as the passage switching device.

What is claimed is:

1. A blowing device configured to blow an air into a vehicle cabin, the blowing device comprising:
a passage member inserted into an air passage from an outside of a wall of the air passage, the air passage being configured to blow a main air into the vehicle cabin, the passage member being configured to blow an added-value air having an added value that is different from that of the main air; and
a passage switching device, wherein
the passage member includes, in the air passage, a passage opening portion through which the added-value air is blown toward a passenger separately from the main air,
the passage member defines a hole portion in a portion of the passage member that is located in the air passage,
the passage switching device is a damper or a rotary door, each of which is configured to selectively open and close the hole portion of the passage member, and
the damper or the rotary door is configured to:
close the hole portion of the passage member in a first state to allow the added-value air to flow out through the passage opening portion via the passage member; and
fluidly connect the hole portion of the passage member to the air passage in a second state to allow the main air to flow out through both the passage opening portion and a region of the air passage other than the passage opening portion.

2. A blowing device configured to blow an air into a vehicle cabin, the blowing device comprising:
a passage member inserted into an air passage from an outside of a wall of the air passage, the air passage being configured to blow a main air into the vehicle cabin, the passage member being configured to blow an added-value air having an added value that is different from that of the main air; and
a passage switching device, wherein
the passage member includes, in the air passage, a passage opening portion through which the added-value air is blown toward a passenger separately from the main air,
the passage member defines a hole portion in a portion of the passage member that is located in the air passage,
the passage switching device is a check valve disposed in the hole portion, and
the check valve is configured to:
close the hole portion of the passage member in a first state to prohibit the added-value air flowing through the passage member from flowing into the air passage through the hole portion and allow the added-value air to flow out through the passage opening portion via the passage member; and
open the hole portion of the passage member in a second state to allow the main air flowing through the air passage to flow into the passage member through the hole portion and to flow out through both the passage opening portion and a region of the air passage other than the passage opening portion.

3. A blowing device configured to blow an air into a vehicle cabin, the blowing device comprising:
a passage member inserted into an air passage from an outside of a wall of the air passage, the air passage being configured to blow a main air into the vehicle cabin, the passage member being configured to blow an added-value air having an added value that is different from that of the main air; and
a passage switching device, wherein
the passage member includes:
in the air passage, a passage opening portion through which the added-value air is blown toward a passenger separately from the main air;
an outside passage member disposed outside of the air passage; and
an inside passage member disposed inside of the air passage,
the passage switching device is a reciprocating body that is configured to reciprocably move along the outside passage member, and
the reciprocating body is configured to:
protrude from the outside passage member into the air passage in a first state to fluidly connect the outside passage member to the inside passage member such that the added-value air flows out through the passage opening portion via the reciprocating body; and
draw back into the outside passage member in a second state such that the main air flowing through the air passage flows out through both the passage opening portion and a region of the air passage other than the passage opening portion.

4. A blowing device configured to blow an air into a vehicle cabin, the blowing device comprising
a passage member inserted into an air passage from an outside of a wall of the air passage, the air passage being configured to blow a main air into the vehicle cabin and defining a blowing opening surface open to the vehicle cabin, the passage member being configured to blow an added-value air having an added value that is different from that of the main air, wherein
the passage member includes:
an outside passage member that is disposed outside of the air passage; and
a rotating member that is disposed in the air passage and includes an inside passage member and a wall, the rotating member being configured to rotate around a rotational axis parallel with an axis of the air passage,
the inside passage member defines, in the blowing opening surface of the air passage, a passage opening portion through which the added-value air is blown toward a passenger separately from the main air, and
the rotating member is configured to:
fluidly connect the outside passage member to the passage opening portion through the inside passage member and fluidly separate the passage opening portion from the air passage by the inside passage member in a first state to allow the added-value air to flow out through the passage opening portion via the outside passage member and the inside passage member; and
close the outside passage member by the wall and fluidly connect the air passage to both the passage opening portion and a region of the blowing opening surface other than the passage opening portion in a second state to prohibit the added-value air from flowing out of the outside passage and to allow the main air to flow out through an entire region of the blowing opening surface.

5. The blowing device according to claim 1, wherein
the air passage includes a blowing opening surface that opens to the vehicle cabin, and
the passage opening portion is disposed to overlap with a portion of the blowing opening surface.

6. The blowing device according to claim 1, wherein
the air passage is configured to blow, as the main air, a conditioned air generated in an air-conditioning unit for conditioning an air in the vehicle cabin.

7. The blowing device according to claim 1, further comprising:
a first airflow adjusting plate disposed in the air passage; and
a second airflow adjusting plate disposed in the passage opening portion of the passage member.
